(19) United States
(12) Patent Application Publication
(10) Pub. No.: US 2008/0296912 A1
(43) Pub. Date: Dec. 4, 2008

(54) REMOTE DOOR ACCESS DEVICE

(76) Inventors: Douglas E. Whitner, Chagrin Falls, OH (US); Brian V. Sokol, Vermilion, OH (US); Michael O'Toole, Darma, OH (US); Robert Soreo, Cigue Hts, OH (US); Mark Vitantonio, South Russell, OH (US); John R. Nottingham, Bratenahal, OH (US); Brian D. Catlett, Shaker Heights, OH (US); John W. Spirk, Gates Mills, OH (US); Jeffrey Ringness, Chagrin Falls, OH (US); Christopher Wojcuich, Cleveland, OH (US); Robert Nelson, Cleveland, OH (US); Peter Zale, University Hts, OH (US)

Correspondence Address: FAY SHARPE LLP, 1100 SUPERIOR AVENUE, SEVENTH FLOOR, CLEVELAND, OH, 44114, US

(21) Appl. No.: 12/128,314

(22) Filed: May 28, 2008

Related U.S. Application Data
(60) Provisional application No. 60/931,961, filed on May 29, 2007.
(60) Provisional application No. 61/020,464, filed on Jan. 11, 2008.

(51) Int. Cl. E05C 1/06

(52) U.S. Cl. 292/144

(57) ABSTRACT

A remotely activated door lock and unlocking device adapted to convert doorknobs and/or deadbolt access locks to remote door access. The device is engageable over the existing doorknob and/or deadbolt lock to allow for remote rotation activation to unlock and open the door. A gear drive motor rotates the doorknob and/or deadbolt. The device can include visual and/or audio indicators related to door actuation and lock status from a remote location.

The present invention claims priority on U.S. Provisional Patent Application Ser. No. 60/931,961 filed May 29, 2007 entitled “Remote Door Access Device”, all of which is incorporated herein by reference.

The present invention also claims priority on U.S. Provisional Patent Application Ser. No. 61/020,464 filed Jan. 11, 2008 entitled “Remote Door Access Device”, all of which is incorporated herein by reference.

The present invention is directed to a device to remotely controlled locks used for access to building structures and the like. The device of the present invention can be used to operate existing conventional key door locks that require a key to be used. The device of the present invention can incorporate the use of a number code, bio-mechanical identification such as fingerprints, and/or encoded cards for security access in unlocking and/or locking a lock. The device of the present invention can be used for unlocking and/or locking a lock on a door from a remote location.

### BACKGROUND OF THE INVENTION

Prior art devices that can be used to lock and/or unlock doors are disclosed in U.S. Pat. Nos. 4,679,834; 4,810,014; and 5,437,174, all of which are incorporated herein by reference. Indeed, one or more features of the these prior art locking and unlocking mechanisms can be used in the device of the present invention.

In U.S. Pat. No. 4,679,834, a door unlocking device can be seen having a latch bolt with a trigger bolt actuated by a solenoid.

In U.S. Pat. No. 4,810,014, a motor driven lock control is disclosed which includes an electronically controlled door lock having motor drives, and a door lock pawl.

In U.S. Pat. No. 5,437,174, a retro-fittable electric and mechanical door lock system is disclosed in which a microprocessor circuit is used that controls a rotary two directional motor for door access.

### SUMMARY OF THE INVENTION

The present invention is directed to a retrofitting remote locking and unlocking device that is adapted for use with existing door locking devices. The locking and unlocking device of the present invention is designed to be fitted onto and/or over a preexisting lock locking mechanism and then lock and/or unlock the door using all or a majority of the preexisting lock locking mechanism. The locking and unlocking device can include a self-contained motor and power source.

In one non-limiting aspect of the present invention, there is provided a remote door access device that is designed to fit over and engage an existing deadbolt lock of an access door (e.g., front door, utility door, garage door, etc.) and to lock and/or unlock the deadbolt lock. In one non-limiting embodiment of the invention, the remote door access device of the present invention engages and rotates the existing lock handle of a deadbolt. In another and/or alternative non-limiting embodiment of the invention, the remote door access device of the present invention can lock and/or unlock an existing deadbolt lock of an access door at a location remote from the existing deadbolt lock. In one non-limiting example, the remote door access device of the present invention can be operated by a control pad and/or panel that is wired and/or wirelessly connected (e.g., RF signal, IR signal, ultrasonic signal, etc.) to the housing of the remote door access device, which control pad and/or panel is positioned remotely from the housing of the remote door access device. In another and/or alternative non-limiting example, the remote door access device of the present invention can be operated by a wireless transmitter via a wireless signal (e.g., RF signal, IR signal, ultrasonic signal, etc.) to cause the remote door access device to lock and/or unlock an existing deadbolt on an access door. In such an arrangement, remote door access device of the present invention allows a user to lock and/or unlock a door without having to manually turn the deadbolt with one's hands. As can be appreciated, the wireless transmitter, control pad and/or panel, when used, can include biometric security, keypad for code and/or security entry, voice commands, etc.; however, this is not required. In one non-limiting arrangement, the remote door access device includes a key fob that generates a wireless signal. The key fob can include separate “lock” and “unlock” buttons along with battery powered, light indicators, RF/IR transmitter circuit board inside (similar to a car door lock key fob); however, this is not required. In still another and/or alternative non-limiting example, the remote door access device of the present invention can allow a user to manually push and/or turn one or more components of the remote door access device to enable a user to manually lock and/or unlock the deadbolt lock. The remote door access device of the present invention provides for a safe, easy installable remote locking system for most conventional doors having a deadbolt lock. n still another and/or alternative non-limiting embodiment of the invention, the remote door access device of the present invention can include one or more visual and or audio status indicators on the housing of the remote door access device, on the control pad and/or panel, and/or on the wireless transmitter to provide information to the user regarding 1) the operation of the remote door access device (e.g., battery power status, locking command selected, unlocking command selected, locking error, unlocking error, incorrect code entered, proper code entered, etc.), and/or 2) the status of the deadbolt (e.g., deadbolt in locked position, deadbolt in unlocked position, etc.).

In another and/or alternative non-limiting aspect of the present invention, there is provided a remote door access device that can be designed such that the remote door access device can be mounted, via a rear housing, to the access door between an existing deadbolt mounting plate and the door itself. In one non-limiting embodiment of the invention, the rear housing of the remote door access device can be designed to accept and fit on most/all current deadbolt assemblies. In another and/or alternative non-limiting embodiment of the invention, the turn knob of the deadbolt can be captured by a flexible, rubberized cover within the remote door access device. The rubberized cover, when used, can be designed to fit and engage most/all deadbolt knobs. In still another and/or alternative non-limiting embodiment of the invention, the remote door access device of the present invention can be at least partially powered by a motor/gear/arrangement. In yet another and/or alternative non-limiting embodiment of the invention, one or more batteries can be used to power the one or more motors in the remote door access device; however; it can be appreciated that the one or more motors can be also or alternatively powered by some other power source. In still yet another and/or alternative non-limiting embodiment of the invention, the remote door access device can include a circuit board, radio frequency (RF) intelligence, IR intelligence, light indicators (e.g., LED indicators, etc.), sound indicators, etc.; however, this is not required. These components and others can be used to control the one or more motors in the device, indicate the status of the device, monitor one or more functions of the device, and/or monitor the functions of the device.

In still another and/or alternative non-limiting aspect of the present invention, the remote door access device can be operated by a key fob. In this operation of the remote door access device, a user leaves his/her home, points the key fob in the general direction of the remote door access device on a door and presses the “lock” button on the key fob. The RF and/or IR signal sent from the key fob is received by the remote door access device on the door and thereby causes components in the remote door access device (e.g., motor, gear, rubberized cover assembly, etc.) to rotate the deadbolt knob to its “locked” position. When pressing the “unlock” button on the key fob, the RF and/or IR signal sent from the key fob is received by the remote door access device on the door and thereby causes components in the remote door access device (e.g., motor, gear, rubberized cover assembly, etc.) to rotate the deadbolt knob to its “unlocked” position. Visible lights and/or audible sounds can be included on the remote door access device and/or key fob to inform the user of the lock or unlock status of the remote door access device. The remote door access device can include a manual override arrangement which can enable a user to manually lock and/or unlock the deadbolt on the door if the remote door access device on the door should somehow fail (e.g., batteries die, motor breaks, etc.), or if the user so desires to manually lock or unlock the door.

In yet another and/or alternative non-limiting aspect of the present invention, the remote door access device is designed to fit over and engage an existing door knob or doorhandle of an access door (e.g., front door, utility door, garage door, etc.) and to move the door knob or doorhandle to an open position and/or closed position, and/or to cause the door knob or doorhandle to become locked and/or unlocked. In one non-limiting embodiment of the invention, the remote door access device of the present invention engages and rotates the existing door knob or doorhandle. In another and/or alternative non-limiting embodiment of the invention, the remote door access device of the present invention can lock and/or unlock an existing door knob or doorhandle of an access door at a location remote from the existing deadbolt lock. In another and/or alternative non-limiting embodiment of the invention, the remote door access device of the present invention can move an existing door knob or doorhandle of an access door to an open and/or closed position at a location remote from the existing door knob or doorhandle. In one non-limiting example, the remote door access device of the present invention can be operated by a control pad and/or panel that is wired and/or wirelessly connected (e.g., RF signal, IR signal, ultrasonic signal, etc.) to the housing of the remote door access device, which control pad and/or panel is positioned remotely from the housing of the remote door access device. In another and/or alternative non-limiting example, the remote door access device of the present invention can be operated by a wireless transmitter via a wireless signal (e.g., RF signal, IR signal, ultrasonic signal, etc.) to cause the remote door access device to lock and or unlock an existing door knob or doorhandle on an access door, and/or move an existing door knob or doorhandle to an open and/or closed position. In such an arrangement, remote door access device of the present invention allows a user to lock and/or unlock a door and/or move an existing door knob or doorhandle to an open and/or close position without having to manually turn the existing door knob or doorhandle with one's hands. As can be appreciated, the wireless transmitter, control pad and/or panel, when used, can include biometric security, key pad for code and/or security entry, voice commands, etc.; however, this is not required. In one non-limiting arrangement, the remote door access device includes a key fob that generates a wireless signal. The key fob can include separate “lock” and “unlock” buttons and/or “open” and “close” buttons along with a battery power, light indicators, RF/IR transmitter circuit board inside (similar to a car door lock key fob); however, this is not required. In still another and/or alternative non-limiting example, the remote door access device of the present invention can allow a user to manually push and/or turn one or more components of the remote door access device to enable a user to manually lock and/or unlock the existing door knob or doorhandle and/or move the existing door knob or doorhandle to an open and/or closed position. The remote door access device of the present invention provides for a safe, easy installable remote locking system for most conventional doors having a door knob or door handle. In still another and/or alternative non-limiting embodiment of the invention, the remote door access device of the present invention can include one or more visual and/or audio status indicators on the housing of the remote door access device, on the control pad and/or panel, and/or on the wireless transmitter to provide information to the user regarding 1) the operation of the remote door access device (e.g., battery power status, locking command selected, unlocking command selected, locking error, unlocking error, incorrect code entered, proper code entered, etc.), and/or 2) the status of the deadbolt (e.g., deadbolt in locked position, deadbolt in unlocked position, etc.).

In still yet another and/or alternative non-limiting aspect of the present invention, there is provided a remote door access device that can be designed such that the remote door access device can be mounted, via a rear housing, to the access door between an existing door knob or doorhandle mounting plate and the door itself. In one non-limiting embodiment of the invention, the rear housing of the remote door access device can be designed to accept and fit on many types of current door knob or doorhandle assemblies. In another and/or alternative non-limiting embodiment of the invention, the turn knob of the door knob or doorhandle can be captured by a flexible, rubberized cover within the remote door access device. The rubberized cover, when used, can be designed to fit and engage most/all turn knobs of a door knob or doorhandle arrangement. In still another and/or alternative non-limiting embodiment of the invention, the turn knob of the door knob or doorhandle can be captured by a belt or strap arrangement within the remote door access device. The belt or strap arrangement, when used, can be designed to fit and engage many types of current turn knobs of a door knob or doorhandle arrangements. In still yet another and/or alternative non-limiting embodiment of the invention, the turn knob of the door knob or doorhandle can be captured by a clamping arrangement within the remote door access device. The clamping arrangement, when used, can be designed to fit and engage many types of current turn knobs of a door knob or doorhandle arrangements. In another and/or alternative non-limiting embodiment of the invention, the remote door access device of the present invention can be at least partially powered by a motor/gear/arrangement. In yet another and/or alternative non-limiting embodiment of the invention, one or more batteries can be used to power the one or more motors in the remote door access device; however; it can be appreciated that the one or more motors can be also or alternatively powered by some other power source. In still yet another and/or alternative non-limiting embodiment of the invention, the remote door access device can include a circuit board, radio frequency (RF) intelligence, IR intelligence, light indicators (e.g., LED indicators, etc.), sound indicators, etc.; however, this is not required. These components and others can be used to control the one or more motors in the device, indicate the status of the device, monitor one or more functions of the device, and/or monitor the functions of the device.

In another and/or alternative non-limiting aspect of the present invention, the remote door access device can be operated key fob. In this operation of the remote door access device, a user leaves his/her home, points the key fob in the general direction of the remote door access device on a door and presses the “lock” button on the key fob. The RF and/or IR signal sent from the key fob is received by the remote door access device on the door and thereby causes components in the remote door access device (e.g., motor, gear, door knob or doorhandle engagement assembly, etc.) to rotate the door knob or doorhandle to its “locked” position. When pressing the “unlock” button on the key fob, the RF and or IR signal sent from the key fob is received by the remote door access device on the door and thereby causes components in the remote door access device (e.g., motor, gear, rubberized cover assembly, etc.) to rotate the door knob or doorhandle to its “unlocked” position. Visible lights and/or audible sounds can be included on the remote door access device and/or key fob to inform the user of the lock or unlock status of the remote door access device. The remote door access device can include a manual override arrangement which can enable a user to manually lock and/or unlock the existing door knob or doorhandle on the door, and/or open the existing door knob or doorhandle on the door if the remote door access device on the door should somehow fail (e.g., batteries die, motor breaks, etc.), or if the user so desires to manually lock or unlock and/or open or close the door.

One non-limiting object of the present invention is to provide a door access device that can be used with preexisting hardware on a door.

Another and/or alternative non-limiting object of the present invention is to provide a door access device that can open, close, unlock and/or lock a door from a location remote from the lock and/or door knob or handle on the door.

Still another and/or alternative non-limiting object of the present invention is to provide a door access device that can wirelessly open, close, unlock and/or lock a door from a location remote from the lock and/or door knob or handle on the door.

Yet another and/or alternative non-limiting object of the present invention is to provide a door access device that can wirelessly unlock and/or lock a deadbolt lock.

Still yet another and/or alternative non-limiting object of the present invention is to provide a door access device that can wirelessly open, close, unlock and/or lock a door that includes a doorknob or door handle.

Another and/or alternative non-limiting object of the present invention is to provide a door access device that can be easily installed and be used with existing door hardware.

These and other aspects and advantages will become apparent to those skilled in the art upon reading and following the description taken together with the accompanying drawings.

### BRIEF DESCRIPTION OF THE DRAWINGS

Reference may now be made to the drawings which illustrate various preferred embodiments that the invention may take in physical form and in certain parts and arrangement of parts wherein:

FIG. 1 illustrates a partial view of a door and door frame which door includes a door knob and one non-limiting embodiment of the door access device of the present invention fitted about a deadbolt knob on the door;

FIG. 2 illustrates the housing of the door access device of FIG. 1 in the open position;

FIG. 3 is an exploded view of the door access device of FIG. 1;

FIG. 4 is an exploded view of a non-limiting key fob that can be used to remotely operate the door access device of FIG. 1;

FIG. 5 illustrates a partial view of a door and door frame which door includes a door knob and another non-limiting embodiment of the door access device of the present invention fitted about a deadbolt knob on the door and being operated remotely by another non-limiting key fob;

FIG. 6 illustrates a partial view of a door and door frame which door includes a prior art door knob for open, close, unlock and/or lock a door;

FIG. 7 illustrates a partial view of a door which door includes another non-limiting embodiment of the door access device of the present invention fitted about the doorknob on the door and a non-limiting remote control device used to remotely operate the door access device; and,

FIG. 8 is an exploded view of the door access device of FIG. 7.

### DETAILED DESCRIPTION OF NON-LIMITING EMBODIMENTS

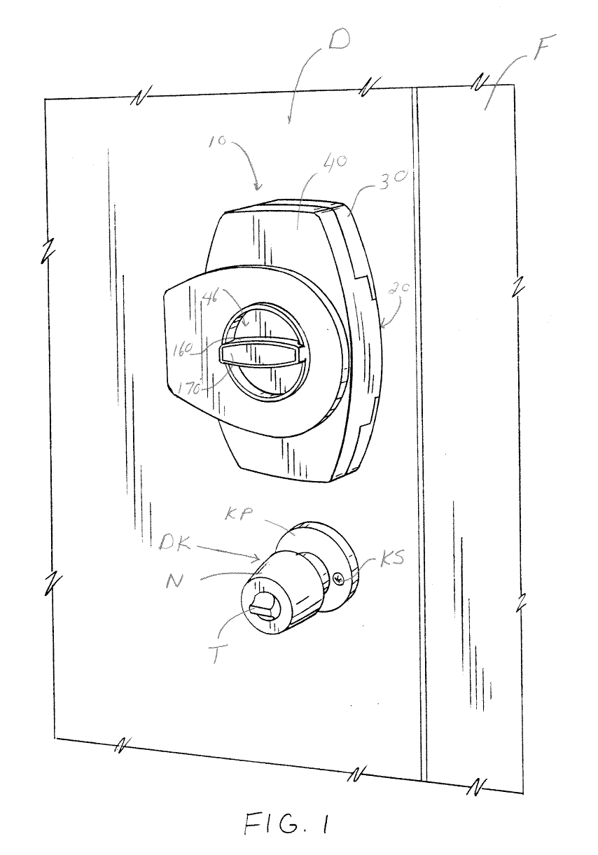

Referring now to the drawings wherein the showings are for the purpose of illustrating a preferred embodiment of the invention only and not for the purpose of limiting same, FIGS. 1-8 illustrate several non-limiting embodiments of the door access device of the present invention.

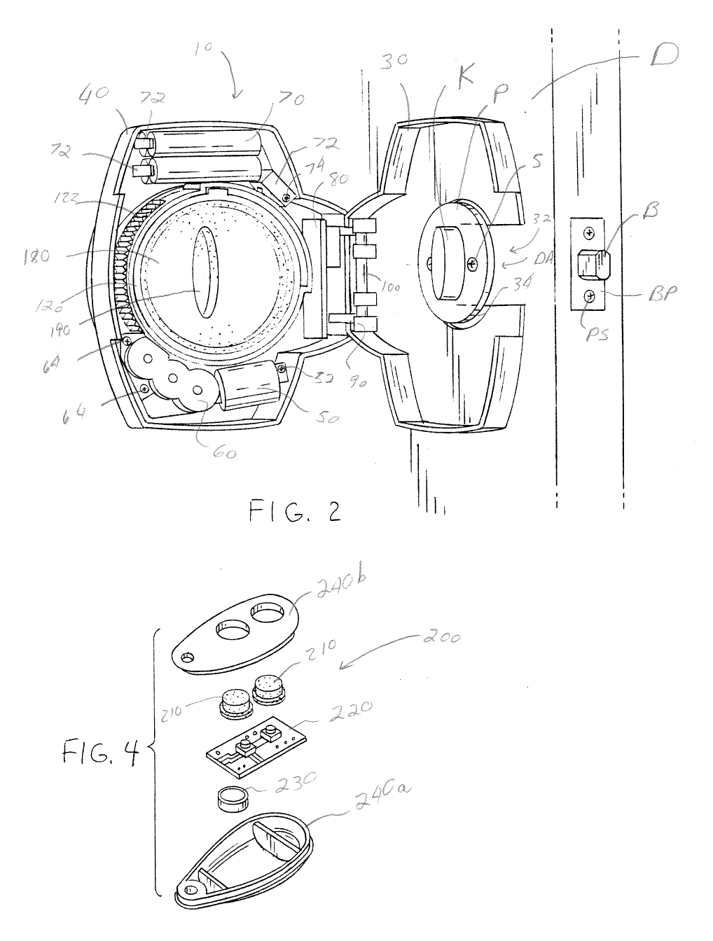

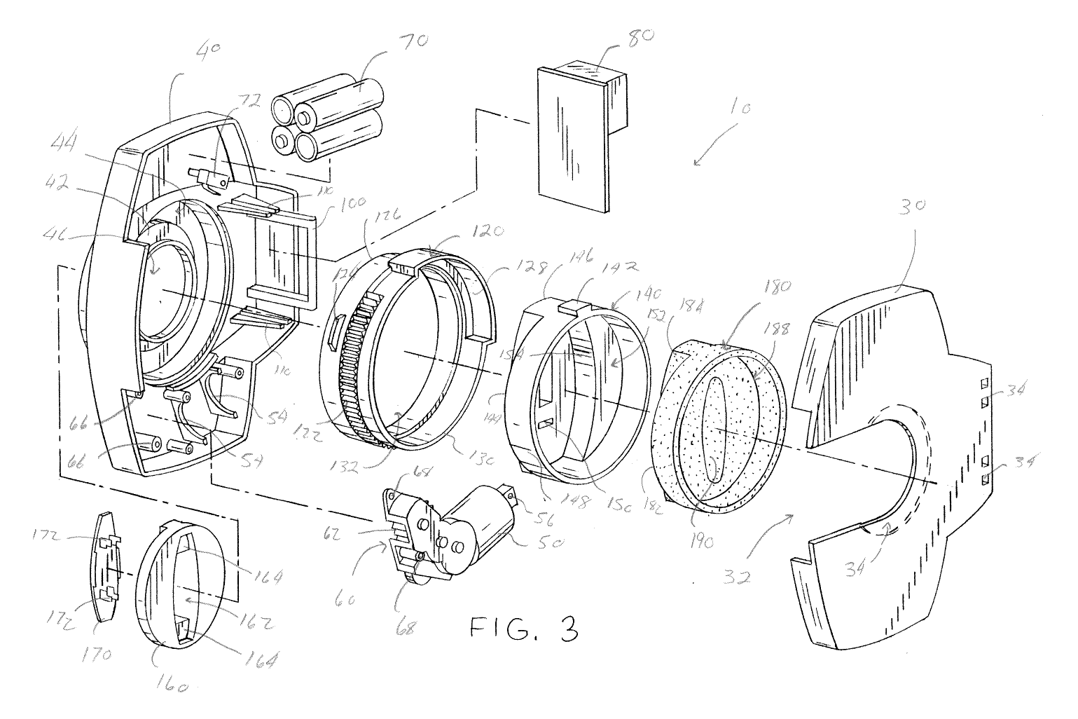

Referring now to FIGS. 1-4, there is illustrated one non-limiting embodiment of a door access device 10 in accordance with the present invention. Door access device 10 includes a housing 20 that is designed to be secured to a door D and to at least partially cover a deadbolt knob K of a deadbolt arrangement DA on the door. As is well known in the art, door D is mounted in a door frame F, typically by one or more hinges, so that the door can be opened and closed. The deadbolt arrangement DA includes a deadbolt knob K and is designed to cause a deadbolt B to move to a retracted or open position and to an extended or locked position. As illustrated in FIG. 2, deadbolt knob K has been rotated such that the deadbolt B is in the extended or locked position. Deadbolt B is at least partially maintained in position by bolt plate BP that is typically secured to the end edge of the door and/or internal components of the deadbolt arrangement by one or more plate screws PS and/or by some other type of connection arrangement. The installation, components and operation of deadbolt arrangements are well known in the art, thus will not be further described herein. FIG. 1 also illustrates a standard doorknob arrangement DK. The doorknob arrangement includes a doorknob N that can partially rotate. The doorknob is at least partially secured to the door by a knob plate KP which is secured to the door and/or internal components of the doorknob arrangement DK by one or more knob screws KS and/or by some other type of connection arrangement. The front face of the doorknob can include a rotating lock tab T that is designed to allow or prevent the rotation of the doorknob. The installation, components and operation of doorknob arrangements are well known in the art, thus will not be further described herein.

Referring now to FIGS. 1-3, the housing 20 of door access device 10 can have any number of shapes, sizes, colors and/or configurations to meet the aesthetic and/or practical aspects and/or functions of the housing. The housing can be made of one or more materials (e.g., wood, metal, plastic, composite materials, ceramic, etc.). The material, color size, shape and/or configuration of the housing is non-limiting. As illustrated in FIG. 1-3, one non-limiting shape and configuration of the housing is shown. Housing 20 is illustrated has a two piece unit that includes a base 30 and a cover 40; however, it can be appreciated that housing 20 can be formed on a single piece or formed by more than two pieces. The base of the housing includes a U-shaped lock slot 32 and a plate recess 34 that is designed to receive plate P as illustrated in FIG. 2. Base 30 can be mounted to door D in a variety of ways (e.g., screw, bolt, adhesive, etc.). As illustrated in FIG. 2, base 30 is simply connected to the door by first loosening the two screws S, and then pulling plate P away from the face door D. After the plate is pulled from the face of the door, base 30 is slipped in between plate P and the face of door D. The lock slot 32 in base 30 enables base 30 to be positioned about the components of the deadbolt arrangement DA without having to partially disassemble the components of the deadbolt arrangement. Once the base is properly positioned between plate P and the face of door D, the two screws D are retightened to cause plate P to sit in plate recess 34 and to clamp base 30 to the face of door D. As such, the installation of the door access device 10 on a door is as simple as loosening and then retightening screws on an existing deadbolt arrangement on a door. As can be appreciated, base 30 can be also at least partially secured to the face of the door by other arrangements (e.g., adhesive, screw, bolt, hook and loop fastener (Velcro), etc.); however, this is not required.

As illustrated in FIGS. 2 and 3, several components of door access device 10 are positioned inside the housing. A motor 50 and gear arrangement 60 are included in the housing. These component are illustrated as being mounted in cover 40 of the housing; however, the motor and/or one or more of the gears can be located on base 30; however, this is not required. Motor 50 is an electric motor. Motor 50 is illustrated as being mounted by screw 52 via mount opening 56 to motor mount 54 in cover 40. As can be appreciated, other arrangements can be used to connect motor 50 to cover 40. The gear arrangement can include one or more gears 62. In one non-limiting arrangement, the gear arrangement includes five (5) gears; however, it can be appreciated that gear arrangement 60 can include more than or less than five (5) gears. The gear arrangement can be formed of a variety of materials (e.g., plastic, metal, etc.). Gear arrangement 60 is illustrated as being connected by screws 64 via mount opening 68 to gear mount 66 in cover 40. As can be appreciated, other arrangements can be used to connect gear arrangement 60 to cover 40. As can also be appreciated, more than one motor can be included in the housing; however, this is not required. Motor 50 is powered by one or more batteries 70. In one non-limiting arrangement, motor 50 is a 6V DC motor. As illustrated in FIG. 3, four (4) batteries are shown to power motor 50; however, it can be appreciated that less than four (4) or more than four (4) batteries can be used to power motor 50. The batteries can be standard batteries (e.g., AAA, AA, A, C, D, 9V, etc.); however, this is not required. The batteries are illustrated as being mounted in cover 40 of the housing; however, the batteries can be located on base 30; however, this is not required. The batteries are designed to contact one or more electrical connectors 72 that are mounted on cover 40 via screw 74 so as to supply power to motor 50 and or other components in the door access device (e.g., control circuit, indicator lights, etc.). Housing 20 is designed to allow a user to easily access and replace the batteries; however, this is not required. As illustrated in FIG. 2, cover 40 is hingeably connected to base 30 so that cover 40 can be opened by a user while base 30 is secured to door D; thereby enabling a user to replace batteries 70 without having to remove base 30 from door D. Cover 40 can be hingeably connected to base 30 in a variety of ways. As illustrated in FIG. 3, base 30 includes four connection openings 34 that can be used to hingeably connect cover 40 to base 30. A hinge bracket 90 is designed to be mounted in connection openings 34 and engage or capture mount bar 100 on cover 40. As can be appreciated, other or additional structures on cover 40 and/or base 30 can be used to hingeably connect cover 40 to base 30. As can also be appreciated, cover 40 can be connected to base 30 in a non-hingeable manner. For example, cover 40 can be snapped onto base 30, connected to base 30 by one or more connectors (e.g., screw, hook and loop fastener (e.g., Velcro), clamp, latch, lock, etc.); however, this is not required.

A circuit 80 is also included in housing 20. Circuit 80 can include one or more electric circuits. Circuit 80 is designed to perform at least two functions, namely 1) at least partially control the operation of motor 60, and 2) receive at least one electromagnetic wave signal or other type signal (e.g., IR signal, RF signal, ultrasonic signal, etc.) as will be described in more detail below. Circuit 80 can perform other or additional functions (e.g., activate and/or illuminate one or more indicator lights, create one or more warning and/or activation and/or status sounds, sense battery power, activate a low battery power alarm, indicate status of deadbolt [locked position, unlocked position], enable security programming, etc.); however, this is not required. Circuit 80 is illustrated as being mounted in cover 40 of the housing; however, the circuit can be located on base 30; however, this is not required. Cover 40 includes two circuit brackets 110 that are designed to secure circuit 80 to cover 40; however, it can be appreciated that other or additional arrangements can be used to secure circuit 80 to cover 40.

Circuit 80 is designed to receive an RF and or IR signal. The circuit generally includes a RF and or IR receiver and/or power activation relays for the motor 50 that are used to at least partially control the operation of the motor in response to encoded transmission commands from a remote offsite wireless transmitter 200. One non-limiting wireless transmitter 200 is illustrated in FIG. 4 as will be described in more detail below.

As illustrated in FIGS. 2 and 3, cover 40 includes a gear ring 120. The gear ring includes a plurality of teeth 122 on a portion of the outside surface that are designed to engage one or more gears 62 on gear arrangement 60 to thereby cause the gear ring to rotate clockwise and counter-clockwise during the operation of motor 50. The gear ring includes a pressure tab 124 that is designed to engage a ramp surface 42 in cover 40. When gear ring 120 rotates counter-clockwise, the thickness of ramp surface 42 increases, thereby causing gear ring to move a little toward deadbolt knob K. When gear ring 120 rotates clockwise, the thickness of pressure tab decreases, thereby allowing gear ring 120 to retract a little from deadbolt knob K. The use of ramp surface 42 and pressure tab 124 is used to ensure that the components of the door access device 10 properly engage the deadbolt knob D when rotating the deadbolt knob between the unlocked and locked positions. The use of ramp surface 42 and pressure tab 124 are not required.

Gear ring 120 includes a circular front end 126 that is designed to be at least partially telescopically received in a cylindrical cavity 44 in cover 40. As can be appreciated, front end 126 and/or cavity 44 can have other shapes; however, this is not required. The shapes of front end 126 and/or cavity 44 allow gear ring 120 to at least partially rotate in cavity 44. Gear ring 120 includes a gear ring recess 128 on a portion of the back end 130 of the gear ring. The gear ring recess is designed to receive a tab 142 on turn ring 140 as will be described in more detail below. The gear ring can be made of a variety of materials (e.g., plastic, metal, composite material, ceramic, wood, etc.).

Turn ring 140 includes a front face 144 that includes a raised handle 146. The outer edge 148 of the turn ring includes a generally circular cross-sectional shape that is fittable in cavity 132 of gear ring 120. The tab 142 on the outer edge fits into gear ring recess 128 when the turn ring is inserted into cavity 132. The gear ring recess limits the amount of rotational movement of the turn ring in the gear ring, and also limits the distance that the turn ring can be inserted into the cavity of the gear ring. During assembly, raised handle 146 protrudes through cavity a32 and up to or through cavity 46 in cover 40. An outer knob 160 and knob lock 170 are connected to the raised handle 146 to rotatably secure the turning ring 140 to cover 40. As illustrated in FIG. 3, outer knob 160 includes a cavity 162 that is shaped and sized to telescopically receive a portion of raised handle 146. Cavity 162 can include stop 164 to limit the distance that raised handle 146 can enter into cavity 162. Knob lock 170 includes a plurality of locking tabs 172 that are designed to engage locking slots 150 in turning ring 140. As can be appreciated, knob lock 170 can be secured to turning ring 140 in other or additional ways (e.g., adhesive, melted seal, screws, clamp, lock, etc.). As can also be appreciated, knob lock can be eliminated and outer knob 160 can be designed to be connected to turning ring 140. As will be explained in more detail below, outer knob 160 and knob lock 170 enable a user to manually lock and unlock the deadbolt arrangement while door access device 10 is secured to the face of door D (e.g., motor fails, batteries discharged, when desired by a user, etc.).

Referring again to FIGS. 2 and 3, a soft cover component 180 is designed to engage deadbolt knob K. The front face 182 of soft cover component 180 includes a raised tab 184. The raised tab is designed to be inserted into cavity 152 of turning ring 140 and to be seated in tab wall 154. The shape and size of the portion of cavity 152 formed by tab wall 154 is generally similar to the shape of and the same size or larger than the size and shape of raised tab 184. Tab wall 154 also functions as a stop to limit the distance soft cover component 180 can be inserted into cavity 152. The back face 186 of soft cover component 180 includes a cavity 188 and knob slot 190. Knob slot is designed to fit over at least a portion of deadbolt knob K. The soft cover component 180 is generally formed of a flexible and/or stretchable material so as to enable cavity 188 to fit over a variety of different shaped deadbolt knobs when cover 40 is closed on to base 30 while base 30 is secured to door D as illustrated in FIG. 1. As can be appreciated, the material used to form soft cover component 180 need not be flexible and/or stretchable material. Generally, the materials used to form gear ring 120, turn ring 140, outer knob 160 and knob lock 170 are formed of durable and generally rigid materials (e.g., wood, hard plastic, metal, etc.), and the soft cover component 180 is generally formed of a less rigid material (e.g, rubber, foam material, etc.); however, this is not required.

As mentioned above, outer knob 160 and knob lock 170 can be used by a user to manually lock and/or unlock the deadbolt arrangement. Door access device 10 is also designed to lock and unlock the deadbolt arrangement by use of a wireless transmitter 200 as discussed above. Referring now to FIG. 4, one non-limiting wireless transmitter 200 in the form of a key fob is shown. The wireless transmitter generally includes one or more buttons 210 or activation surfaces: however, more than two buttons or less than two button can be included on the wireless transmitter. As can be appreciated, the wireless transmitter can be activated by voice command and/or some motion command. As illustrated in FIG. 4, the wireless transmitter includes a circuit 220 and power source 230, such as a battery. The power source and circuit are generally at least partially contained in a housing 240. As illustrated in FIG. 3, the housing can be a two piece unit (240a, 240b); however, it can be appreciated that the housing can be a one piece unit or include three or more pieces. Circuit 220 is designed to transmit a coded signal (e.g., RF coded signal, IR codes signal, ultrasonic coded signal, etc.) to circuit 80 in housing 20. As illustrated in FIG. 4, circuit 220 is designed to transmit a RF coded signal. The coded signal can be preprogrammed and/or be programmed by a user. The wireless transmitter can include one or more indicator lights, not shown, to provide information to a user (e.g., low battery, a button as been pressed, signal to lock door sent, signal to unlock door sent, etc.); however, this is not required.

The operation of door access device 10 will now be described. After the door access device 10 is install on door D that includes a deadbolt arrangement DA, as previously described above, the user (not shown) is able to operate door access device 10 via wireless transmitter 200 which transmits an RF control code signal to the RF receiver in circuit 80 located in housing 20. The one or more buttons on the wireless transmitter can be used to control the type of RF coded signal being transmitted; however, this is not required. For instance, FIG. 4 illustrates the wireless transmitter as including two buttons 210. One button can be used to transmit an RF coded signal that causes the deadbolt B to be moved to a locked position and the other button can be used to transmit an RF coded signal that causes the deadbolt B to be moved to an unlocked position. Circuit 80, upon receiving the RF signal causes motor 50 to operate. The operation of motor 50 causes the one or more gears in gear arrangement 60 to rotate, which in turn causes gear ring 120 to rotate clockwise or counter-clockwise. The rotation of gear ring 120 causes turn ring 140, and soft cover component 180 to rotate thereby rotating knob K to cause the deadbolt B to move to a locked or unlocked position. The housing 20 can include audible and/or visual indicators to indicate to the user when the deadbolt is in a locked or unlocked position; however, this is not required. Door access device 10 of the present invention thus provides an easy and effective way to remotely lock and unlock a door that includes a deadbolt.

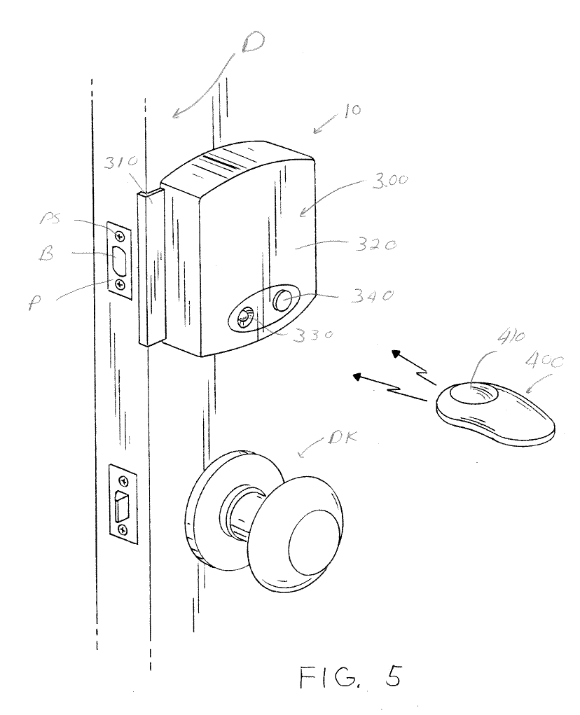

Referring now to FIG. 5, another non-limiting embodiment of door access device 10 of the present invention is shown. The door access device includes a housing 300. This housing design is different from housing 20 shown in FIGS. 1-3. Housing 300 includes a side arm 310 that is used to position the housing properly on the door. The inclusion of side arm 310 on housing 300 is optional.

Housing 300 does not includes an outer knob that can be used by a user to manually lock and/or unlock the deadbolt arrangement. As can be appreciated, housing 300 can include an outer knob. The internal components and function and operation of such components in housing 300 of door access device 10 are generally the same as used in housing 20 as described above, thus will not be further described in detail herein. Housing 300 is illustrated as being a one piece unit; however, it will be appreciated that housing 300 can be formed of more than one piece.

The front face 320 of housing 300 includes an indicator light 330 and a button 340. The inclusion of either or both of indicator light 330 and a button 340 is optional. Indicator light 330 can be used to indicate the status of the door access device (e.g., locked position, unlocked position), battery status (e.g., low battery, good battery, etc.), receiving signal status, error status and/or operation status (e.g., on, off, motor running, etc.). The color of the light, the flashing sequence of the light, the light intensity of the light and/or the on/off status of the light can be used to provide information to the user about one or more features, functions and/or status of the door access device.

Button 340 can be used by a user to manually lock or unlock the deadbolt arrangement. For example, pressing the button by the user can cause the door access device to lock and/or unlock the deadbolt arrangement. The button can be designed such that the number of presses by the user causes the door access device to operate in a certain fashion (e.g., one press of the button causes the door access device to move the deadbolt arrangement into the locked position, two presses of the button causes the door access device to move the deadbolt arrangement into the unlocked position, etc.); however, this is not required.

The wireless transmitter 400 illustrated in FIG. 5 is also a different design from wire transmitter 200 in FIG. 4. Wireless transmitter 400 is a simpler design than wireless transmitter 200. Wireless transmitter 400 includes a single button 410 that sends an IR and/or RF signal to the circuit in housing 300. The pressing of button 410 by the user can cause the door access device to lock and/or unlock the deadbolt arrangement. The button 410 on the wireless transmitter can be designed such that the number of presses by the user causes the door access device to operate in a certain fashion (e.g., one press of the button causes the door access device to move the deadbolt arrangement into the locked position, two presses of the button causes the door access device to move the deadbolt arrangement into the unlocked position, etc.); however, this is not required.

It should be noted that one non-limiting aspect of the door access device illustrated in FIGS. 1-5 is the relatively simple and inexpensive construction and components, and the fact that it can be easily retrofitted to existing deadbolt arrangements by the average consumer without any sophisticated disassembly of conventional door locks and replacing same which is currently the only viable system presently available.

Referring now to FIGS. 6-8, there is illustrated a self-contained, self-powered, retro-fittable remote locking and unlocking door access device 500 that is adapted to fit over and engage an existing doorknob arrangement DK of door D. The prior art door knob arrangement DK illustrated in FIG. 6 is similar to the door knob arrangement DK illustrated in FIG. 1. As such, similar components of the doorknob arrangement have been labeled the by the same letter designation. FIG. 6 illustrates a doorknob bolt KB extending from the side edge of door D. The doorknob bolt KB is at least partially maintained in positioned by door plate DP which is secured to door D and/or one or more internal components of doorknob arrangement DK by knob screws KS and/or by some other connection arrangement. The operation of prior art doorknob arrangement and the components used in such arrangements are well known in the art, thus will not be described in detail herein.

The remote door access device of the invention as illustrated in FIG. 6-8 engages and rotates the existing doorknob or lock handle on a door by remote activation from a wireless transmitter. The remote door access device provides for a safe, easy installable remote locking system to any conventional door having door lock parameters. Visual and/or audio status indicators can be provided to inform the user as to the lock, open door lock or unlocked condition and operational sequence during use of the remote door access device; however, this is not required.

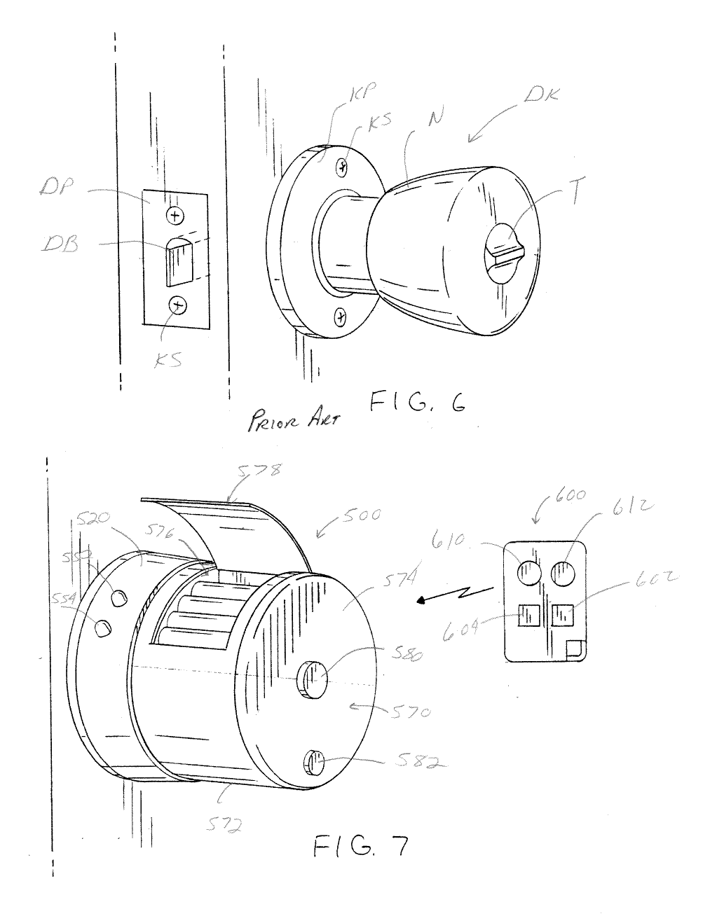

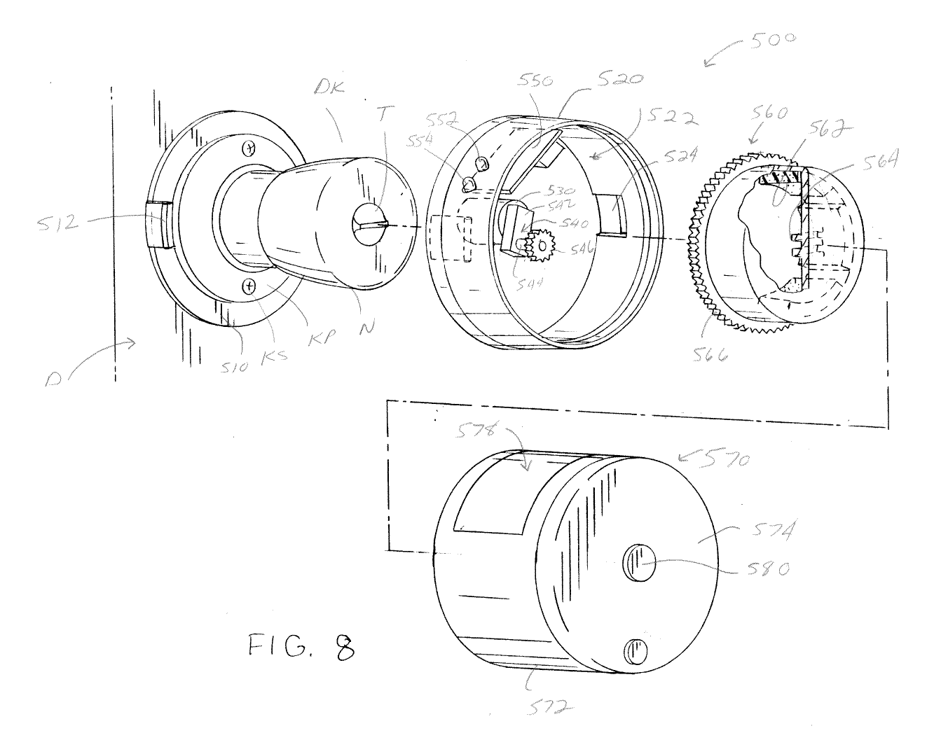

Referring now to FIGS. 7 and 8, door access device 500 includes a mount plate 510. Mount plate 510 includes two clips 512 that are designed to be secured to an base section 520. The mount plate is designed to be secured between the face of door D and the doorknob plate KP as illustrated in FIG. 8. The mount plate is secured to door D by first removing doorknob N. The removal of doorknob N is generally accomplished by removing the two screws KS and then pulling the doorknob off door D. Once the doorknob is removed, mount plate 510 is positioned against the face of the door and the doorknob is replaced back on the door and the two screws KS are reinserted and tightened to secure both the doorknob and mount plate 510 to the door.

Once the doorknob is resecured to the door, base section 520 is positioned about the doorknob and secured to the mount plate. Base section 520 has a generally circular coss-sectional shape; however, this is not required. The mount plate and the base section are generally made of durable materials (e.g., wood, metal, plastic, composite materials, etc.). The base section includes a cavity 522 that is large enough to allow the door knob to pass through the cavity as the base section is secured to the mount plate. The interior surface of the base section includes two clip cavities 524 that are designed to engage clips 512 on the mount plate and thereby secure the base section to the mount plate. As can be appreciated, other or additional arrangements can be used to secure the base section to the mount plate.

The base section 520 is illustrated in FIG. 8 as including a motor 530 that is secured in cavity 522. Motor 530 can be the same or similar to motor 50 as described above; however, this is not required. A gear arrangement 540 is also illustrated as being connected to motor 530 and positioned in cavity 522. The gear arrangement can be the same or similar to gear arrangement 60 as described above; however, this is not required. In one non-limiting arrangement, the gear arrangement 540 includes a gear reduction configuration 542 and an output drive shaft 544 with a key drive gear 546 thereon. A circuit 550 is also illustrated as being mounted in cavity 522. The operation and/or function of circuit 550 can be the same or similar to that of circuit 80 as described above; however, this is not required. In one arrangement, circuit 550 includes an IR and/or RF receiver and one or more power activation relays for motor 530. The IR and/or RF receiver is designed to receive signals (e.g., coded signals, etc.) from a wireless transmitter 600 as illustrated in FIG. 7. The circuit 550 is illustrated as including two lights 552, 554. These lights are optional. the lights, when used, can be used to provide information to a user about the door access device (e.g., device in locked position, device in unlocked position, battery power level, receiving signal from wireless transmitter, operation error, etc.).

The wireless transmitter 600 can have the same or similar operations and/or functions as wireless transmitters 200 and/or 400 as discussed above; however, this is not required. Wireless transmitter 600 is illustrated as including two buttons 602, 604 and two light indicators 610, 612. Pressing of one of the buttons by a user can be designed to cause the door access device 500 to lock the doorknob arrangement and the pressing of the other button by a user can be designed to cause the door access device to unlock the doorknob arrangement. Pressing of one button can cause one of the light indicators to illuminate and the pressing of the other button can cause the other light indicator to illuminate. As can be appreciated, other or additional functions can be associated with one or both of the buttons. As can also be appreciated, one or both of the light indicators can be used to provide other or additional information to a user regarding the door access device. As can also be appreciated, wire transmitter 600 can have a design, configuration and/or function that is the same or similar to wireless transmitters 200 and/or 400; however, this is not require.

Referring again to FIG. 8, door access device 500 includes a knob engagement drive cap 560. The drive cap 560 has a generally concave configuration with an interior surface 562; however, other shapes can be used. The interior surface 562 has a dimension that is designed to registerably fit over and engage an outer surface of the doorknob N. The interior surface 562 can include one or more resilient and yielding gripping pods 564 that are annularly spaced about the interior surface of the cavity. These one or more gripping pods are designed to be flexible so as to adjustably conform and engage the exterior surface of doorknob N during operation of the door access device. The outer surface of the drive cap includes a plurality of teeth 566 that is designed to engage the key drive gear 546 on gear arrangement 540. The operation of motor 540 causes the key drive gear 546 to rotate in a certain direction which in turn causes the drive cap to be rotated in a certain direction. At least a portion of the drive cap is designed to be positioned in cavity 522 of base section 520. The size of cavity 522 and the shape and size of drive cap 560 are selected to enable the drive cap to rotate in cavity 522 when the drive cap is positioned on and engages doorknob N.

The door access device includes a cover portion 570 that is designed to be secured to base section 520. Cover portion 570 can be secured to base section 520 in a variety of ways (e.g., threaded engagement, adhesive, clip, clamp, screws, etc.). Cover portion 570 is illustrated as having an annular side-wall 572 extending from a base 574; however, it can be appreciated that cover portion 570 can have other shapes. Cover portion 570 includes a battery compartment 576 that is formed within the interior surface of side wall 572. The battery compartment can be open and closed by an exterior access door 578 that is hingeably secured to the side wall 572 so as to provide easy access to the battery compartment. As can be appreciated, the access door 578 can be removably connected to the battery compartment in other or additional ways. The batteries that are used to power motor 530, circuit 550 and/or lights 552,554 can be standard batteries (e.g., AAA, AA, A, C, D, 9V, etc.); however, this is not required. As illustrated in FIG. 7, the battery compartment is designed to hold four batteries; however, this is not required. As can also be appreciated, one or all of the batteries can be positioned in cavity 522 instead of in cover portion 570; however, this is not required. as can also be appreciated, cover portion 570 and base section 520 can be formed into a single component; however, this is not required.

The cover portion 570 can include a manual direct contact activation button 580 on the center portion of the cover; however, this is not required. The pressing of activation button 580 causes motor 530 to become active and to rotate drive cap 560. The rotation of drive cap 560 results in the locking and/or unlocking of doorknob arrangement DR. As such, the activation button can be used to manually lock and/or unlock the doorknob arrangement when desired and/or when the wireless transmitter is not working and/or cannot be located.

The base 574 of cover portion 570 can also include an alarm arming button 582; however, this is not required. The alarm arming button can be used to sound an alarm when the door access device is used and/or if the doorknob is turned. This alarm can inform a home owner of unauthorized use of the door access device and/or unauthorized attempted entry through door D.

Once door access device 500 is mounted onto doorknob N, lights 552 can be used to indicate the status of the door lock. A red light can be used to indicate that the door is locked and a green light can be used to indicate that the door is unlocked. In operation, after installation of the door access device on doorknob N, the user (not shown) activates the door access device 500 via a wireless transmitter 600 as illustrated in FIG. 7. The wireless transmitter transmits an IR and/or RF control code signal to a receiver in circuit 550, which circuit is in communication with motor 530. The operation of motor 530 causes the gear arrangement 540 to operate, which in turn causes drive cap 560 to rotate in a clockwise or counter-clockwise direction. The rotation of the drive cap results in the turning of doorknob N to cause the door to be locked and/or unlocked. The indicator lights 552, 554 indicate whether the door is unlocked or locked.

It will be evident that simple manual operation as a safety override feature is also available from inside by simply grasping the cover 570 and rotating the cover by hand which simultaneously disengages the control motor access associated with the primary source of rotational torque applied thereto.

It will thus be seen that the objects set forth above, among those made apparent from the preceding description, are efficiently attained, and since certain changes may be made in the constructions set forth without departing from the spirit and scope of the invention, it is intended that all matter contained in the above description and shown in the accompanying drawings shall be interpreted as illustrative and not in a limiting sense. The invention has been described with reference to preferred and alternate embodiments. Modifications and alterations will become apparent to those skilled in the art upon reading and understanding the detailed discussion of the invention provided herein. This invention is intended to include all such modifications and alterations insofar as they come within the scope of the present invention. It is also to be understood that the following claims are intended to cover all of the generic and specific features of the invention herein described and all statements of the scope of the invention, which, as a matter of language, might be said to fall therebetween.

We claim:

1. A door access device for locking and unlocking a door that can be retrofitted on existing doorknob or deadbolt hardware of a door, said door access device comprising a housing, a motor, a circuit, a knob interface and a wireless transmitter, said housing designed to be at least partially secured to the door by existing doorknob or deadbolt hardware of the door and to at least partially cover an existing doorknob or deadbolt on at least one side of the door, said motor, circuit, and knob interface at least partially positioned in said housing, said control designed to receive a wireless signal from said wireless transmitter and to at least partially control an operation of said motor based on said received wireless signal, said knob interface designed to engage the doorknob, door handle or deadbolt on the door, said motor connected or interconnected to said knob interface to cause said knob interface to rotate in a clockwise direction, a counterclockwise direction, and combinations thereof, said rotation of said knob interface designed to cause the doorknob, door handle or deadbolt on the door to rotate to a locked position, an unlocked position, and combinations thereof when said knob interface is in engagement with the doorknob, door handle or deadbolt on the door.

2. The door access device as defined in claim 1, including a gear arrangement to interconnect said motor to said knob interface.

3. The door access device as defined in claim 1, including a power supply at least partially positioned in said housing, said power supply designed to at least partially supply power to said motor, said circuit, and combinations thereof.

4. The door access device as defined in claim 2, including a power supply at least partially positioned in said housing, said power supply designed to at least partially supply power to said motor, said circuit, and combinations thereof.

5. The door access device as defined in claim 1, wherein said housing includes a base and a cover, said cover removably connected to said base, said base designed to be secured to the door at least partially by the existing doorknob, door handle or deadbolt hardware of the door.

6. The door access device as defined in claim 4, wherein said housing includes a base and a cover, said cover removably connected to said base, said base designed to be secured to the door at least partially by the existing doorknob, door handle or deadbolt hardware of the door.

7. The door access device as defined in claim 1, wherein said knob interface including a flexible cavity designed to partially receive and secure to the doorknob, door handle or deadbolt on the door.

8. The door access device as defined in claim 6, wherein said knob interface including a flexible cavity designed to partially receive and secure to the doorknob, door handle or deadbolt on the door.

9. The door access device as defined in claim 1, wherein a front face of said housing includes a manual door opening arrangement, said manual door opening arrangement including a manual push button, a rotating knob, and combinations thereof.

10. The door access device as defined in claim 8, wherein a front face of said housing includes a manual door opening arrangement, said manual door opening arrangement including a manual push button, a rotating knob, and combinations thereof.

11. The door access device as defined in claim 1, including a visual indicator on said housing to indicate whether said doorknob, door handle or deadbolt on the door is in a locked position or an unlocked position.

12. The door access device as defined in claim 10, including a visual indicator on said housing to indicate whether said doorknob, door handle or deadbolt on the door is in a locked position or an unlocked position.

13. A device for locking and unlocking a door comprising a deadbolt attachment and a key fob, said deadbolt attachment designed to be secured to a door that includes a deadbolt, said deadbolt attachment including a housing, an electric motor at least partially positioned in the housing, an electric circuit at least partially positioned in the housing, and a deadbolt engager, said electric circuit designed to receive at least one electromagnetic wave signal, said electric circuit designed to at least partially control the operation of said electric motor, said key fob including an electric circuit, said electric circuit designed to transmit at least one electromagnetic wave signal to said electric circuit of said deadbolt attachment.

14. The device as defined in claim 13, including a gear arrangement to interconnect said motor to said knob interface, said gear arrangement at least partially positioned in said housing.

15. The device as defined in claim 14, including a power supply at least partially positioned in said housing, said power supply designed to at least partially supply power to said motor, said circuit, and combinations thereof.

16. The device as defined in claim 15, wherein said housing includes a base and a cover, said cover removably connected to said base, said base designed to be secured to the door at least partially by the existing deadbolt hardware of the door.

17. The door access device as defined in claim 16, wherein said deadbolt engager including a flexible cavity designed to partially receive and secure to the deadbolt on the door.

18. The device as defined in claim 17, wherein a front face of said housing includes a manual door opening arrangement, said manual door opening arrangement including a manual push button, a rotating knob, and combinations thereof.

19. The device as defined in claim 18, including a visual indicator on said housing to indicate whether said deadbolt on the door is in a locked position or an unlocked position.

20. A device for locking and unlocking a door comprising a doorknob attachment and a key fob, said doorknob attachment designed to be secured to a door that includes a doorknob or door handle, said doorknob attachment including a housing, an electric motor at least partially positioned in the housing, an electric circuit at least partially positioned in the housing, and a doorknob engager, said electric circuit designed to receive at least one electromagnetic wave signal, said electric circuit designed to at least partially control the operation of said electric motor, said key fob including an electric circuit, said electric circuit designed to transmit at least one electromagnetic wave signal to said electric circuit of said doorknob attachment.
